(19) United States
(12) Patent Application Publication
(10) Pub. No.: US 2020/0036062 A1
(43) Pub. Date: Jan. 30, 2020

(54) ACCUMULATOR ARRANGEMENT

(71) Applicant: Mahle International GmbH, Stuttgart (DE)

(72) Inventors: Stefan Hirsch, Stuttgart (DE); Caroline Janzen, Stuttgart (DE); Heiko Neff, Auenwald (DE)

(21) Appl. No.: 16/523,994

(22) Filed: Jul. 26, 2019

(30) Foreign Application Priority Data
Jul. 27, 2018 (DE) 102018212626.7

(51) Int. Cl. H01M 10/613; H01M 2/10; H01M 10/625; H01M 10/6568; H01M 10/6556; B60L 50/64; B60L 58/26

(52) U.S. Cl. CPC H01M 10/613; H01M 2/1083; H01M 10/625; H01M 2220/20; H01M 10/6556; B60L 50/64; B60L 58/26; H01M 10/6568

(57) ABSTRACT

An accumulator arrangement for a hybrid or electric vehicle may include a plurality of rigid battery cells and a cooling device. The plurality of battery cells may have a plurality of bearing surfaces and may be stacked in a stacking direction to form a battery block. The cooling device may include a plurality of cooling elements through which a cooling fluid is flowable. A respective cooling element may be arranged between adjacent battery cells and clamped thereto. The respective cooling element may abut against a bearing surface of each of the adjacent battery cells facilitating a transfer of heat. The cooling device may further include a fluid distributor having a variable shape in the stacking direction and through which the cooling fluid is flowable from a flow connection to a return connection via a fluid chamber. The fluid distributor may be fluidically connected to the plurality of cooling elements.

### CROSS-REFERENCE TO RELATED APPLICATIONS

This application claims priority to German Patent Application No. DE 10 2018 212 626.7, filed on Jul. 27, 2018, the contents of which are hereby incorporated by reference in its entirety

### TECHNICAL FIELD

The invention relates to an accumulator arrangement for a hybrid or electric vehicle.

### BACKGROUND

An accumulator arrangement or a traction battery, respectively, for a hybrid or electric vehicle typically comprises a plurality of individual battery cells, which are combined to form one battery module or also a plurality of battery modules. The individual battery cells are electrically interconnected in the respective battery module and supply the hybrid or electric vehicle with energy. In the case of the further development of the traction batteries, a short charging time is increasingly strived for, which leads to a high thermal load on the traction batteries. An effective temperature control of the individual battery cells is thus necessary in the traction battery.

For the respective battery module, a cooling device can thus for example be provided for this purpose, which cools the respective battery cells at the current collectors. The cooling device can thereby comprise a cooling plate, through which a coolant flows, to which the current collectors of the battery cells are fixed so as to transfer heat. Heat-conducting plates, which systematically dissipate the heat to the cooling plate, as is described, for example in DE 10 2008 061 755 A1, can additionally also be arranged between the battery cells. Such heat-conducting plates are disadvantageously fixed rigidly to the cooling plate, so that an expansion of the battery cells as a result of the charging state or of the aging of the battery cells can be partially prevented. Unwanted tensions can thereby be built up in the battery module. A solution for pouch cells is known from DE 10 2010 021 922 A1, in the case of which film elements, through which the cooling fluid can flow, are arranged between the pouch cells. The film elements are formed by two film layers, which are fixed to one another by means of a seam. The film elements abut against the pouch cells at a pressure, which is built up by the coolant. Other concepts, such as, for example, a housing comprising improved thermal properties, are further also known in DE 10 2013 206 581 A1.

### SUMMARY

It is the object of the invention to specify an improved or at least alternative embodiment for an accumulator arrangement of the generic type, in the case of which the described disadvantages are at least partially overcome.

This object is solved according to the invention by means of the subject matter of the independent claim(s). Advantageous embodiments are the subject matter of the dependent claim(s).

An accumulator arrangement is provided for a hybrid or electric vehicle and has a plurality of rigid battery cells comprising bearing surfaces located opposite one another, which facing one another with the bearing surfaces, are stacked to form a battery block in the stacking direction. The accumulator arrangement furthermore has a cooling device comprising a plurality of cooling elements, through which the cooling fluid can flow. The respective cooling element is thereby arranged between the adjacent battery cells and is clamped to the latter to form the battery block. The respective cooling element furthermore abuts against the bearing surfaces of the respective adjacent battery cells so as to transfer heat. According to the invention, the cooling device has a fluid distributor, which changes its shape in the stacking direction and through which the cooling fluid can fluid from a flow connection to a return connection via a fluid chamber, and which is fluidically connected to the respective cooling elements of the cooling device.

The flexible fluid distributor does not prevent a deformation of the battery block in the stacking direction, so that no unwanted tensions are built up in the battery block in response to the deformation of the battery cells as a result of the charging state or of the aging, and an excessive clamping of the battery block can be prevented in an advantageous manner. Unwanted tensions in the fluid distributor itself can furthermore be prevented in an advantageous manner, so that the tightness of the cooling device can be improved and the service life of the accumulator arrangement as a whole can be extended. The fluid distributor can advantageously consist of a fluid-tight and/or diffusion-tight material. The fluid-tight and/or diffusion-tight material is preferably plastic, such as polypropylene or polyethylene or polystyrene or, alternatively, a layered composite material, such as polypropylene-aluminum-polypropylene or polypropylene-aluminum-polyamide. A thickness of the material thereby lies between 0.1 mm and 0.6 mm.

It can advantageously be provided that, between the adjacent cooling elements, the fluid distributor in each case has a deformation area, which preferably deforms in response to a deformation of the fluid distributor in the stacking direction. When the battery block is not clamped, the fluid distributor is thereby not deformed in the deformation areas, and when the battery blocked is clamped, it is deformed in the deformation areas, so that the fluid distributor remains tension-free in the stacking direction in the case of the clamped battery block. The respective deformation areas thereby extend transversely to the stacking direction and along the battery cells, so that the respective cooling elements between the respective battery cells outside of the deformation areas can be fluidically connected to the fluid distributor. The deformation areas can be formed, for example, by areas comprising a smaller thickness of the material forming the fluid distributor. The deformation areas comprising the connection points of the respective cooling elements are thus arranged on the fluid distributor so as to alternate in the stacking direction.

The respective cooling element of the cooling device can advantageously have a fluid ingress and a fluid egress, which are arranged on a bottom side of the cooling element so as to be spaced apart from one another. The fluid ingress can furthermore be fluidically connected to a fluid inlet, and the fluid egress to a fluid outlet of the fluid distributor of the cooling device. An even supply of the cooling fluid to the respective fluid inlets and an even discharge of the cooling fluid from the respective fluid outlets is made possible thereby. At least one sealing contour or at least one sealing surface can in each case advantageously be embodied on the respective cooling element around the fluid ingress and around the fluid egress. The respective sealing contour or the respective sealing surface can then in each case seal the connection point between the fluid ingress and the fluid inlet or between the fluid egress and the fluid outlet to the outside.

It can advantageously be provided that an assembly distance, which is defined in the stacking direction, between the respective adjacent cooling elements is larger in the case of the non-deformed deformation areas, than a cell thickness of the respective battery cells, which is defined in the stacking direction. It can alternatively or additionally be provided that an element distance, which is defined in the stacking direction, between the respective adjacent fluid inlets and between the respective adjacent fluid outlets of the fluid distributor in the case of the non-clamped battery block is larger than in the case of the clamped battery block. In response to the clamping of the battery block, the fluid distributor changes its shape, and the element distance thus also changes in the stacking direction. The fluid distributor thereby preferably changes in the deformation areas, which are arranged between the respective cooling elements and which extend transversely to the stacking direction along the battery cells. The cooling elements are thereby fluidically connected to the fluid distributor outside of the respective adjacent deformation areas, so that the connection points between the fluid distributor and the respective cooling elements are not or only slightly influenced by the change of the shape of the fluid distributor in the deformation areas. The connection points between the fluid distributor and the respective cooling element can then be simplified and can thus be securely sealed due to the sealing contours at the fluid ingresses and at the fluid egresses of the respective cooling element.

In the case of an advantageous further development of the accumulator arrangement, it is provided that a plurality of flow channels for supplying the cooling fluid from the flow connection to the respective cooling elements and for discharging the cooling fluid from the respective cooling elements to the return connection are embodiment within the fluid chamber. The respective flow channels are thereby preferably arranged as a Tichelmann circuit in order to optimize a flow of the cooling fluid through the fluid chamber and the respective cooling elements.

It can advantageously be provided that the fluid distributor is a separate flat component for supplying cooling fluid to the respective cooling elements of the cooling device and for discharging cooling fluid from the respective cooling elements of the cooling device. The fluid chamber is thereby embodied completely inside the fluid distributor and is defined by the latter to the outside. The fluid distributor thus forms a conventional distributor or a conventional distributor pipe, respectively, as well as a conventional collector or a conventional manifold, respectively, in the accumulator arrangement. The fluid distributor is in particular a connected component, which is flat. In this context, “flat” means that the height of the fluid distributor compared to its width and its length is significantly smaller, or is smaller by a multiple, respectively. The fluid distributor can then abut on the battery block on one side and can be oriented parallel to the stacking direction.

The fluid distributor is preferably formed of an upper shell and a lower shell, which are fixed to one another in a fluid-tight manner—preferably by means of a substance-to-substance bond. The fluid chamber is then defined between the upper shell and the lower shell, and the cooling fluid can flow through it. The flow connection and the return connection can then be embodied in the upper shell as well as in the lower shell. If the fluid distributor has the flow channels, they can be formed, for example, by upper shell and lower shell of the fluid distributor, which are fixed to one another area by area and by means of a substance-to-substance bond in a linear manner. A connection structure, which defines a deformation of the fluid distributor, can furthermore be embodied on the upper shell and/or on the lower shell within the fluid chamber. In particular an unwanted inflating or an unwanted collapsing of the fluid distributor at a pressure, which is built up by the cooling fluid, can thus be prevented. The connection structure preferably has punctiform and/or oval-shaped and/or lens-shaped and/or linear connection areas, which are preferably oriented in the flow direction of the cooling fluid.

It can advantageously be provided that the respective cooling element has a frame, which revolves around the bearing surfaces of the respective adjacent battery cells on the edge side in the circumferential direction. An interior of the cooling element, through which the coolant can flow, is then arranged between the frame and the adjacent battery cells. The frame places the respective adjacent rigid battery cells—for example prismatic battery cells—at a distance to one another in an advantageous manner, so that the battery block has a length, which is predetermined in the stacking direction. The battery block can thus already be clamped with a predetermined clamping force in response to the assembly. The frame furthermore revolves around the bearing surfaces of the respective adjacent battery cells on the edge side in the circumferential direction, so that a deformation of the battery cells in an area, which is framed by the frame, of the bearing surfaces of the respective adjacent battery cells is thus not prevented. Independently of the deformation of the battery cells, the battery block thus remains clamped at the predetermined clamping force due to the charging state and the aging, and an excessive clamping of the battery block can be prevented in an advantageous manner. The cooling fluid can furthermore flow through the interior between the frame and the adjacent battery cells, so that the respective adjacent battery cells can be cooled efficiently by the cooling fluid. The service life of the battery cells as a whole can thus be significantly increased.

It can be provided in an advantageous manner that the frame is fixed to the bearing surfaces of the adjacent battery cells in a fluid-tight manner, so that the bearing surfaces of the adjacent battery cells define the interior of the cooling element, through which the fluid can flow, with the frame. The frame can thereby be connected to the respective adjacent battery cells by means of a substance-to-substance bond—for example adhered—or in a non-positive manner—for example clamped. The frame can consist, for example, of an electrically insulating material. The frame can thus be made of plastic, such as polypropylene, by means of injection molding. The cooling fluid can furthermore also be dielectric, in order to minimize the risk of a short-circuit in the battery block. The cooling device comprising the cooling elements embodied thereon is constructed in a simple manner, so that the production effort as a whole can be reduced. The cooling fluid can furthermore flow directly around the bearing surfaces of the respective adjacent battery cells, whereby the heat exchange between the bearing surfaces of the battery cells and the cooling fluid can be intensified, and the cooling of the battery cells can thus be improved.

It can alternatively be provided that flexible separating layers are fixed to the frame in a fluid-tight manner transversely to the stacking direction. The separating layers then define the interior of the cooling element, through which the fluid can flow with the frame. In the case of this embodiment of the cooling element, the separating layers can abut against the bearing surfaces of the respective adjacent battery cells at a pressure, which is built up by the cooling fluid, inside the interior, so that, independently of the deformation of the battery cells, the separating layers can abut against the bearing surfaces, and the heat exchange between the battery cells and the cooling fluid can take place in the interior of the cooling element. The frame and the respective separating layers can thereby consist of an electrically insulating material, so that the electrical properties of the respective battery cells adjacent to the cooling element are not influenced. In addition, the cooling fluid can be dielectric. The frame can consist, for example, of plastic, preferably of polypropylene, and can be produced by means of injection molding. The respective separating layer can be formed of plastic, preferably of polypropylene or polyethylene or polystyrene. Alternatively, the respective separating layer can consist of a layered composite material, preferably of polypropylene-aluminum-polypropylene or of polypropylene-aluminum-polyamide. A thickness of the respective separating layer in the stacking direction can thereby lie between 0.1 mm and 0.6 mm. Advantageously, the respective separating layer and the frame are diffusion-tight, so that the cooling element is fluid-tight to the outside.

In addition, it can advantageously be provided that at least one of the respective separating layers has a reinforcement structure, by means of which the deformation of the respective separating layer can be limited. In particular an unwanted inflating or an unwanted collapsing of the respective separating layers at a pressure, which is built up by the cooling fluid, can thus be prevented. The reinforcement structure thereby preferably has punctiform and/or oval-shaped and/or lens-shaped and/or linear embossings or neps or areas. The embossings or the neps or the areas of the reinforcement structure can thereby be oriented in the flow direction of the cooling fluid, in order to optimize the flow of the cooling fluid through the interior.

In the case of an advantageous further development of the accumulator arrangement according to the invention, it is provided that, on the respective frame at least on one side and at least area by area, a holding collar is embodied, which protrudes away from the frame in the stacking direction and which fixes the respective abutting battery cell transversely to the stacking direction at least area by area. The holding collar can thereby protrude on one side as well as on both sides in the stacking direction and can thus fix one of the battery cells as well as the two adjacent battery cells in the battery block transversely to the stacking direction. The holding collar can in particular support the weight of the respective battery cell during normal operation as well as in response to a strong acceleration—such as, for example, in the case of a crash. The cooling element thus advantageously fulfills thermal as well as mechanical functions, whereby the overall construction of the cooling device and thus the overall construction of the accumulator arrangement can be simplified.

It can advantageously be provided that the frame has a predetermined frame thickness in the stacking direction and that the respective adjacent battery cells are thus fixed in the clamped battery block at a predetermined cell distance identical to the frame thickness relative to one another. The frame thickness is preferably identical in the circumferential direction and lies between 0.5 mm and 5 mm. The cell distance of the respective adjacent battery cells thus preferably lies between 0.5 mm and 5 mm at least in the areas abutting against the frame. The cell distance of the respective adjacent battery cells corresponds to a distance of the bearing surfaces thereof, which face one another, in the stacking direction or to a width of the respective interior of the cooling element, respectively, which is formed between the bearing surfaces, which face one another, in the stacking direction. It goes without saying that the width of the interior as well as the distance of the bearing surfaces to one another can change during operation of the accumulator arrangement in an area of the bearing surfaces, which is framed by the frame, of the respective adjacent battery cells. The cell distance of the two adjacent battery cells, however, remains constant in the areas of the bearing surfaces, which abut against the frame, and corresponds to the frame thickness of the frame.

In the case of a further development of the battery block, it is provided that the battery block is clamped by at least one cell block tension rod, which extends in the stacking direction. The respective cooling element is then fixed to the at least one cell block tension rod in a positive manner by means of at least one form-fitting unit. In this advantageous manner, the individual cooling elements and thus also the battery cells arranged between the respective cooling elements can be fixed to the at least one cell block tension rod. The at least one cell block tension rod can in particular support the weight of the respective battery cells and of the respective cooling elements during normal operation as well as in response to a strong acceleration—such as, for example, in the case of a crash. The at least one cell block tension rod can be arranged below the battery block for this purpose, wherein “below” refers to the accumulator arrangement, which is installed into the hybrid or electric vehicle. It can alternatively or additionally be provided that the battery block is clamped by at least one cell block tie anchor, which extends in the stacking direction, and that the at least one cell block tension rod has a plurality of mounting brackets protruding transversely to the stacking direction on both sides for fixing the accumulator arrangement to the hybrid or electric vehicle. The at least one cell block tension rod is then preferably arranged with the mounting brackets below the battery block, in order to be able to support the weight of the battery block.

Independently of the embodiment of the at least one cell block tension rod, the battery block is preferably arranged between at least two cell block tension rods, which are oriented in the stacking direction and which abut against the battery block on opposite sides thereof. The cell block tension rods can thereby be embodied differently. In addition, the battery block can be arranged between two clamping plates, which, on opposite sides of the battery block, abut against the latter transversely to the stacking direction. The respective clamping plates and thus also the battery block arranged between the clamping plates can then be clamped to one another in the stacking direction by means of the respective cell block tension rods. The battery block can thereby in particular be clamped evenly and the created clamping force can be introduced evenly into the battery block. The cell block tension rods and/or the clamping plates can consist, for example, of steel or of aluminum or of fiber-reinforced plastic.

It is provided in the case of an advantageous further development of the accumulator arrangement that the respective cooling elements are arranged in the battery block so as to alternate with the respective battery cells in the stacking direction. The respective cooling element thereby in each case follows one of the respective battery cells or in each case two of the battery cells abutting against one another. If the respective cooling element in each case follows one of the respective battery cells, the respective battery cells in the battery block can be cooled on the two bearing surfaces and thus optimally. If the respective cooling element in each case follows two of the battery cells, which abut against one another, the number of the cooling elements in the battery block and thus the weight of the battery block can be reduced.

The accumulator arrangement can advantageously have a housing comprising a top part and comprising a bottom part, which are fixed to one another in a fluid-tight manner and which form a fluid-tight receiving space for the battery block. The top part and the bottom part can thus be fixed to one another by means of a substance-to-substance bond—by means of a welding connection or by means of an adhesive connection. The top part and/or the bottom part can consist of a fluid-tight and/or diffusion-tight and/or thermally insulating material. The material can be plastic, such as polypropylene or polyamide or can alternatively be a layered composite material, such as a polypropylene-aluminum composite material or a polypropylene-steel composite material. A thickness of the top part and/or of the bottom part can thereby lie between 1 mm and 3.5 mm, whereby the top part and/or the bottom part are particularly light and the weight of the accumulator arrangement can be reduced in an advantageous manner.

In summary, the fluid distributor is fixed in the accumulator arrangement in a tension-free manner and does not prevent a deformation of the battery cells in the stacking direction as a result of the charging state or of the aging. In addition, the battery cells can be cooled effectively and on both sides. In the accumulator arrangement according to the invention, the cooling elements furthermore combine thermal as well as mechanical functions, whereby the number of the individual parts in the accumulator arrangement can be reduced and the overall construction of the accumulator arrangement can be simplified.

Further important features and advantages of the invention follow from the subclaims, from the drawings, and from the corresponding figure description on the basis of the drawings.

It goes without saying that the above-mentioned features and the features, which will be described below, cannot only be used in the respective specified combination, but also in other combinations or alone, without leaving the scope of the present invention.

### BRIEF DESCRIPTION OF THE DRAWINGS

Preferred exemplary embodiments of the invention are illustrated in the drawings and will be described in more detail in the following description, wherein identical reference numerals refer to identical or similar or functionally identical components.

FIGS. 1 to 4 show views of an accumulator arrangement according to the invention;

FIGS. 5 to 8 show views of a cooling element of a cooling device in the accumulator arrangement according to the invention;

FIG. 9 shows a view of a cooling device in the accumulator arrangement according to the invention;

FIG. 10 shows a view of a fluid distributor of the cooling device in the accumulator arrangement according to the invention;

FIG. 11 shows a sectional view of the cooling element shown in FIG. 5 to FIG. 8 in the accumulator arrangement according to the invention;

FIG. 12 shows a sectional view of the accumulator arrangement shown in FIG. 1 to FIG. 4;

FIGS. 13 to 16 show sectional views of the accumulator arrangement according to the invention in response to the assembly and during operation.

### DETAILED DESCRIPTION

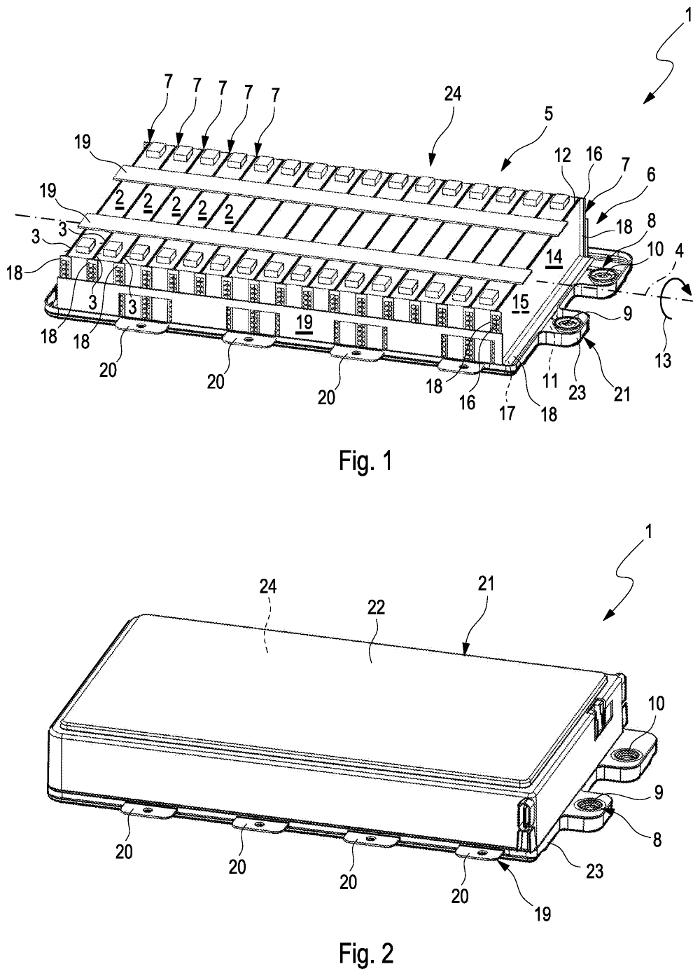

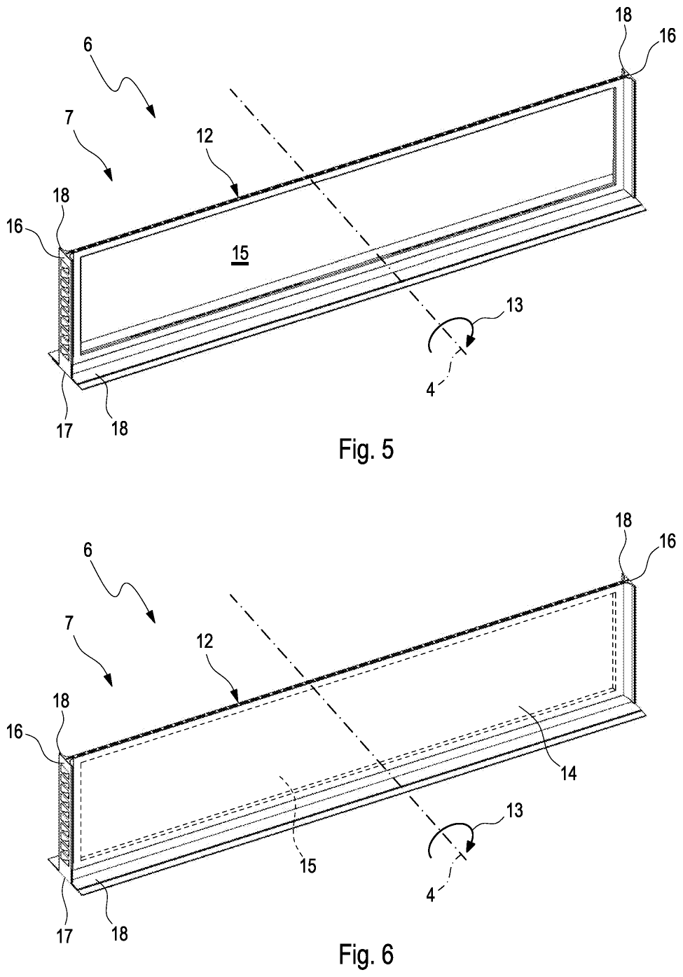

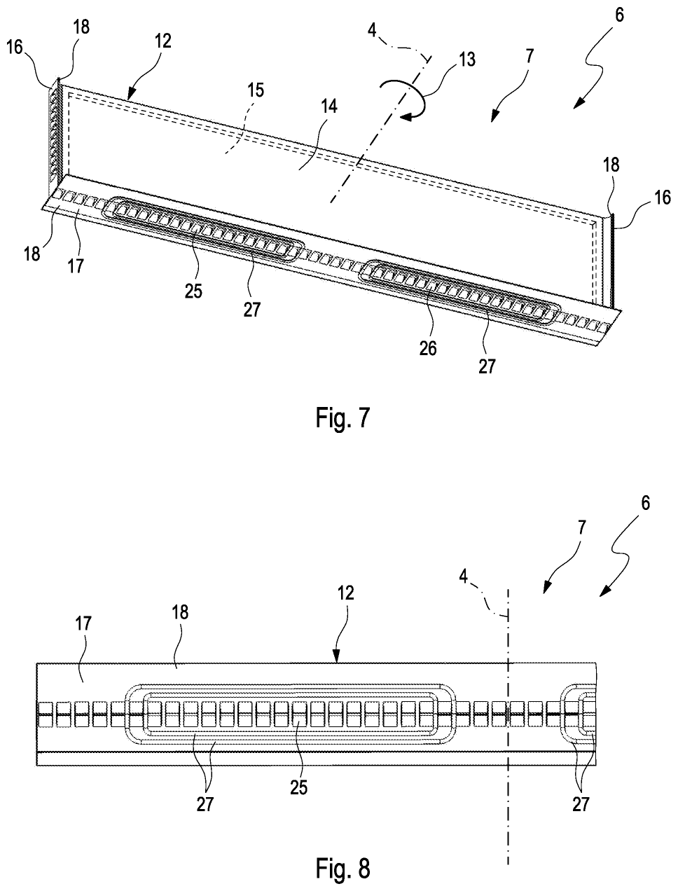

FIG. 1 to FIG. 4 show schematic views of an accumulator arrangement 1 according to the invention for a hybrid or electric vehicle. The accumulator arrangement 1 has a plurality of rigid—and in particular prismatic—battery cells 2 comprising bearing surfaces 3 located opposite one another, which, facing one another with the bearing surfaces 3, are stacked to form a battery block 5 in the stacking direction 4. The accumulator arrangement 1 furthermore has a cooling device 6, through which the cooling fluid can flow and which comprises a plurality of cooling elements 7, through which the cooling fluid can flow, and a fluid distributor 8, through which the cooling fluid can flow. The respective cooling element 7 is arranged between the adjacent battery cells 2 and abuts against the bearing surfaces 3 of the respective adjacent battery cells 2 so as to transfer heat. The cooling elements 7 and the battery cells 2 are clamped with one another in the battery block 5 in the stacking direction 4. In this exemplary embodiment, the respective cooling elements 7 are arranged in the battery block 5 so as to alternate with the respective battery cells 2 in the stacking direction 4. The respective cooling element 7 thereby in each case follows one of the respective battery cells 2, so that the respective battery cells 2 are cooled in the battery block 5 on the two bearing surfaces 3. The fluid distributor 8 is arranged on one side of the battery block 5 and the cooling fluid can flow through it from a flow connection 9 to a return connection 10 via a fluid chamber 11. The fluid distributor 8 is fluidically connected to the respective cooling elements 7 of the cooling device 6, so that the cooling fluid can be supplied into the respective cooling element 7 and can be discharged from the cooling element 7. The construction of the cooling device 6, of the cooling elements 7, and of the fluid distributor 8 will be described in more detail below on the basis of FIG. 5 to FIG. 12.

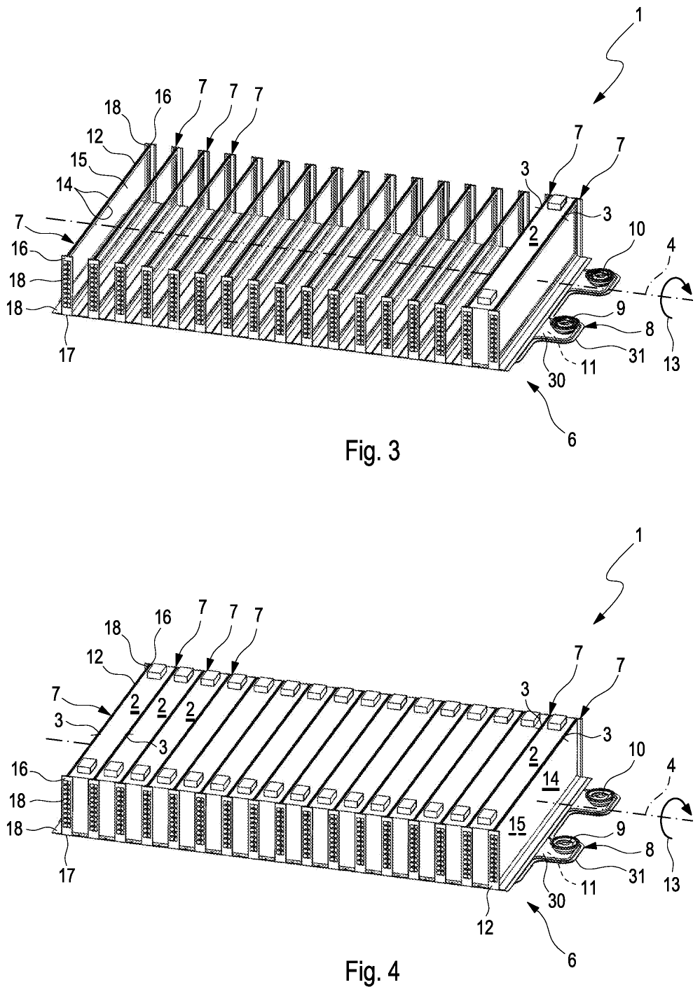

The respective cooling element 7 thereby as frame 12, which revolves around the bearing surfaces 3 of the respective adjacent battery cells 2 on the edge side in the circumferential direction 13. Flexible separating layers 14, which define an interior 15 of the cooling element 7 with the frame 12, are fixed to the frame 12 in a fluid-tight manner transversely to the stacking direction 4. The interior 15 of the respective cooling element 7 is advantageously connected to the fluid chamber 11 of the fluid distributor 8 and the cooling fluid can flow through it. On opposite sides 16 and on a bottom side 17 of the cooling element 7, a holding collar 18 is in each case formed, which protrudes away from the cooling element 7 on both sides in the stacking direction 4—as can in particular be seen in FIG. 3. The respective holding collar 18 thereby fixed the respective abutting battery cells 2 transversely to the stacking direction 4. The holding collar 18 on the bottom side 17 of the cooling element 7 can furthermore support the weight of the respective battery cells 2 during normal operation and the holding collars 18 on the sides 16 in response to a strong acceleration—such as, for example, in the case of a crash.

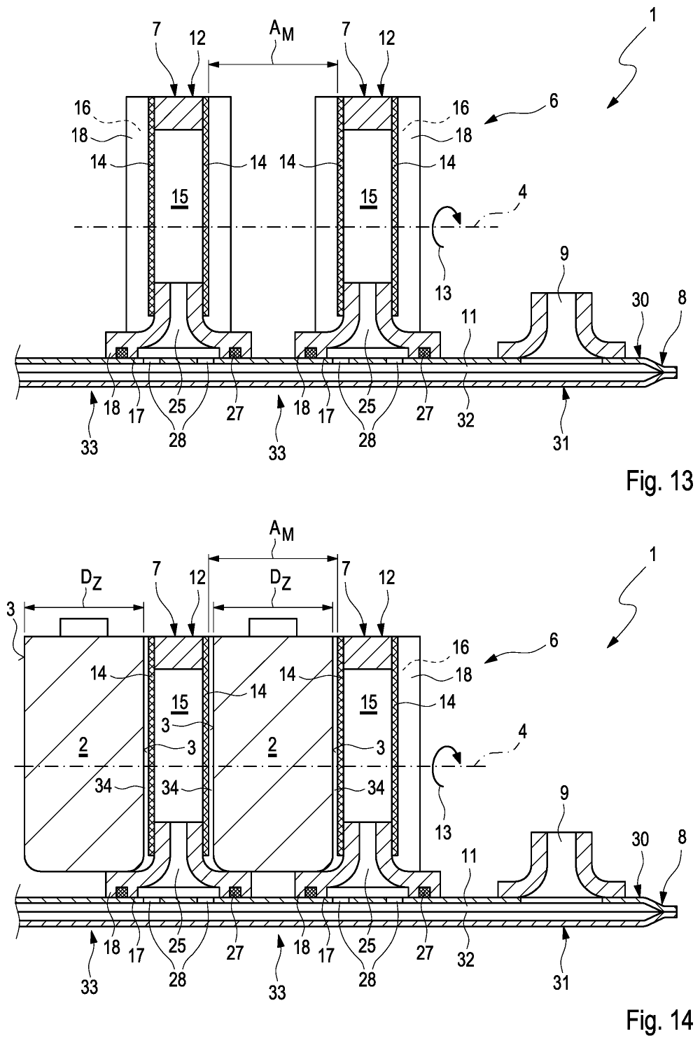

As shown in FIG. 1, the battery block 5 is clamped by means of a plurality of cell block tension rods 19 extending in the stacking direction 4, and clamping plates—not shown here—in the stacking direction 3. The cell block tension rods 19 can consist, for example, of steel or of aluminum or of fiber-reinforced plastic. The respective battery cells 2 are fixed at a distance from one another by the respective cooling elements 7 in the battery block 5, as will be described in more detail below on the basis of FIG. 13 to FIG. 16. The cell block tension rod 19 arranged below the battery cells 2 thereby supports the weight of the respective battery cells 2 and of the cooling device 6 and has mounting brackets 20 protruding transversely to the stacking direction 4 on both sides. The mounting brackets 20 thereby protrude from a housing 21 of the accumulator arrangement 1—as shown in FIG. 2—so that the accumulator arrangement 1 can be fixed to the hybrid or electric vehicle by means of the mounting brackets 20. The housing 21 is constructed in two parts and has a top part 22 and a bottom part 23, which are fixed to one another in a fluid-tight manner and which form a fluid-tight receiving space 24 for the battery block 5. The top part 22 and the bottom part 23 can consist, for example, of plastic and can have a thickness of between 1 mm and 3.5 mm.

In the accumulator arrangement 1 according to the invention, the cooling element 7 places the respective adjacent rigid battery cells 2 at a distance to one another in an advantageous manner and does not prevent a deformation of the battery cells 2 as a result of the charging state or the aging. Independently of the deformation of the battery cells 2, the battery block 5 thus remains clamped at the predetermined clamping force and an excessive clamping of the battery block 5 can be prevented in an advantageous manner. The advantageous effect of the cooling element 7 in the accumulator arrangement 1 according to the invention will be described in more detail below on the basis of FIG. 13 to FIG. 16. The cooling fluid can furthermore flow through the interior 15 of the cooling element 7 in an advantageous manner, so that the respective adjacent battery cells 2 can be cooled by the cooling fluid on both sides and in an efficient manner. As a whole, the service life of the battery cells 2 can be significantly increased in the accumulator arrangement 1 according to the invention.

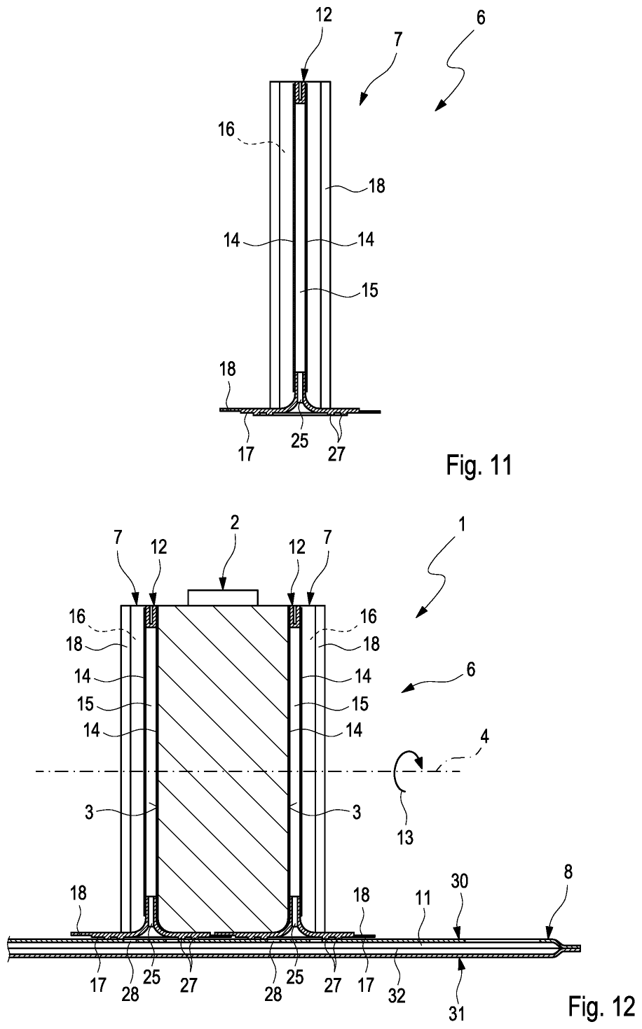

FIG. 5 to FIG. 8 shows views of the cooling element 7 of the cooling device 6. A sectional view of the cooling element 7 is shown in FIG. 11. The frame 12 of the cooling element 7 has—as already described above—the holding collars 18, which protrude on the opposite sides 16 and on both sides on the bottom side 17 of the cooling element 7 in the stacking direction 4. A fluid ingress 25 and a fluid egress 26, which go through the frame 12, are furthermore embodied on the bottom side 17 of the cooling element. The interior 15 of the cooling element 7 is fluidically connected to the fluid chamber 11 of the fluid distributor 8 via the fluid ingress 25 and the fluid egress 26. For this purpose—see also FIG. 10 and FIG. 12—the fluid ingress 25 is fluidically connected to a fluid inlet 29 of the fluid distributor 8 and the fluid egress 26 to a fluid outlet 29 of the fluid distributor 8 of the cooling device 6. To seal the cooling device 6, a sealing contour 27 is in each case embodied on the respective frame 12 around the fluid ingress 25 and around the fluid egress 26. As shown in FIG. 12, the respective sealing contour 27 abuts against the fluid distributor 8 around the fluid inlet 28 or around the fluid outlet 29 and seals the respective connection point between the fluid distributor 8 and the respective cooling element 7.

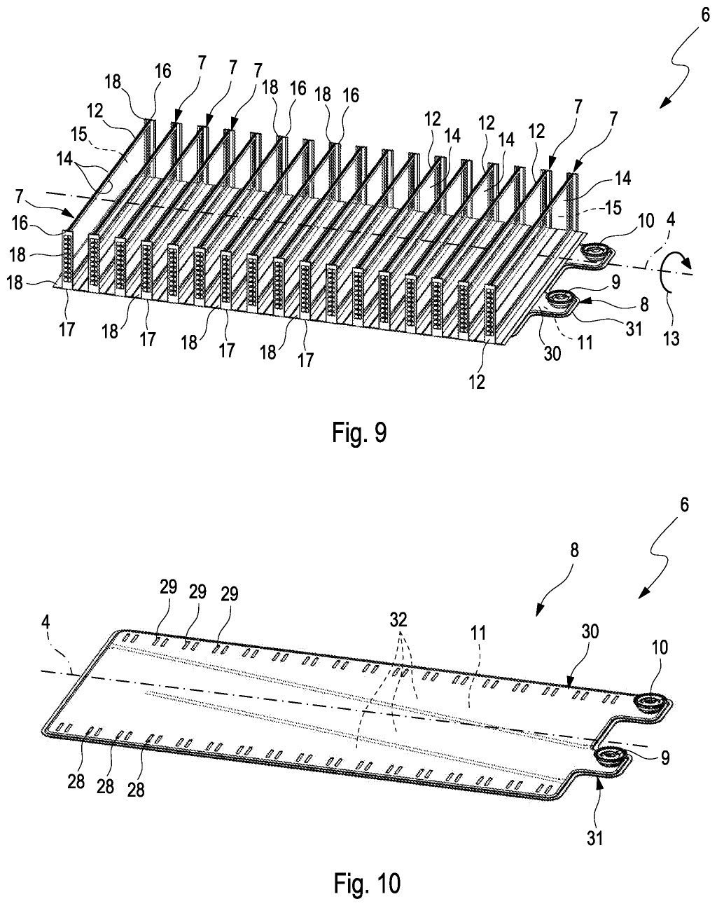

FIG. 9 shows a schematic view of the cooling device 6 in the accumulator arrangement 1. As already described above, the cooling device 6 has the plurality of cooling elements 7 and the fluid distributor 8. The cooling elements 7 are thereby fluidically connected to the fluid distributor 8. The cooling fluid can thereby flow through the cooling device 6 from the feed connection 9 via the fluid chamber 11 of the fluid distributor 8 and then via the fluid ingresses 25, the interiors 15, and the fluid egresses 26 of the cooling elements 7, and subsequently via the fluid ingresses 29 and the fluid chamber 11 to the return connection 10 of the fluid distributor 8.

FIG. 10 shows a schematic view of the fluid distributor 8 of the cooling device 6. The fluid distributor 8 can change its shape in the stacking direction 4, as will be described in more detail below on the basis of FIG. 13 to FIG. 16. As already described above, the cooling fluid can flow through the fluid distributor 8 from the feed connection 9 to the return connection 10 via the fluid chamber 11. The fluid distributor 8 has an upper shell 30 and a lower shell 31, which are fixed to one another in a fluid-tight manner—preferably by means of a substance-to-substance bond. The fluid chamber 11 is then defined between the upper shell 30 and the lower shell 31. The flow connection 9 and the return connection 10 are embodied in the upper shell 30 here. The fluid distributor 8 preferably consists of a fluid-tight and diffusion-tight plastic comprising a thickness of between 0.1 mm and 0.6 mm. A plurality of flow channels 32 for supplying the cooling fluid from the feed connection 9 to the respective cooling element 7 and for discharging the cooling fluid from the respective cooling elements 7 to the return connection 10 are furthermore embodied within the fluid chamber 11. The respective flow channels 32 are thereby arranged as a Tichelmann circuit, in order to provide for an even flow of the cooling fluid through the fluid chamber 11 and through the cooling elements 7.

FIG. 11 shows a schematic sectional view of the cooling element 7 of the cooling device 6 shown in FIG. 5 to FIG. 8. As already described above, the cooling element 7 has the frame 12 and the flexible separating layers 14, which define the interior 15 of the cooling element 7. The cooling fluid can flow through the interior 15, so that the bearing surfaces 3 of the respective adjacent battery cells 2, which abut against the separating layers 14, can be cooled.

FIG. 12 shows a sectional view of the accumulator arrangement 1. The battery cell 2 is arranged here between two cooling elements 7 of the cooling device 6 and abuts against the respective cooling elements 7 with the bearing surfaces 3. On the bearing surfaces 3, the battery cell 2 thereby exchanges the heat with the cooling fluid in the terror 15 of the cooling element 7 via the respective separating layers 14. The battery cell 2 can thereby be cooled effectively and on both sides. The respective cooling element 7 is thereby fluidically connected to the fluid distributor 8, whereby the respective connection point between the fluid ingress 25 of the cooling element 7 and the fluid inlet 28 of the fluid distributor 8 is sealed to the outside by means of the respective sealing contour 27. The respective connection point between the fluid egress 26 of the cooling element 7 and the fluid outlet 29 of the fluid distributor 8, which is not shown here, is also sealed to the outside in the same way by means of the respective sealing contour 27.

FIG. 13 to FIG. 15 show schematic sectional views of the accumulator arrangement 1 in response to the assembly, and FIG. 16 shows the accumulator arrangement 1 during operation. According to FIG. 13—as well as according to FIG. 9—the cooling device 6 is already formed, and the cooling elements 7 are fluidically connected to the fluid distributor 8. The respective connection points between the cooling elements 7 and the fluid distributor 8 are sealed to the outside by means of the sealing contours 27. In the stacking direction 4, the adjacent cooling elements 7 thereby have an assembly distance A_{M} to one another, which is larger than a cell thickness D_{Z} in the stacking direction 4. Deformation areas 33, which extend transversely to the stacking direction 4 parallel to the battery cells 2 or to the cooling elements 7, respectively, are furthermore arranged between the respective fluid inlets 28—and also the fluid outlets 29, which are not shown here—of the fluid distributor 8.

According to FIG. 14, the respective battery cells 2 are arranged between the cooling elements 7 and are supported on the holding collars 18 on the bottom side 17 of the respective cooling elements 7. Due to the fact that the assembly distance A_{M} is larger than the cell thickness D_{Z}, gaps 34 are formed between the bearing surfaces 3 of the respective battery cell 2 and the separating layers 14 of the adjacent cooling elements 7.

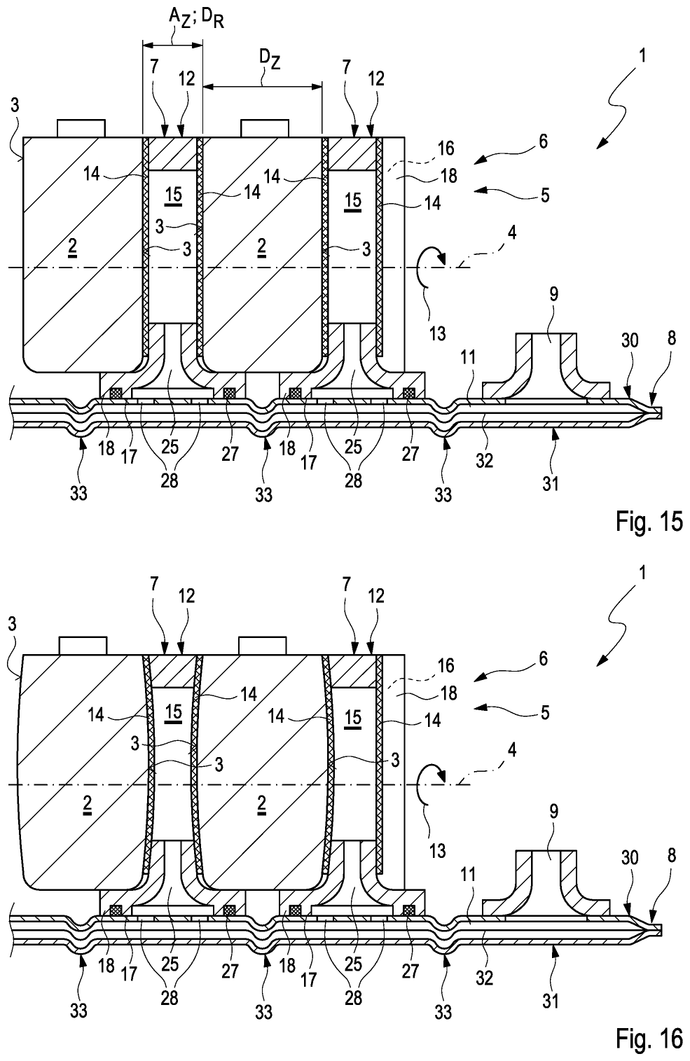

In FIG. 15, the battery block 5 from FIG. 14 is now clamped in the stacking direction 4. The bearing surfaces 3 of the respective battery cells 2 abut against the adjacent separating layers 14 of the adjacent cooling elements 7 so as to transfer heat, and can be cooled. The fluid distributor 8 has thereby deformed in the deformation areas 33, so that no unwanted tensions are built up in the battery block 5 and in the fluid distributor 8. Due to the fact that the frame 12 has a predetermined frame thickness D_{R} in the stacking direction 4, the respective adjacent battery cells 2 in the clamped battery block 5 are fixed relative to one another at a predetermined cell distance A_{Z} identical to the frame thickness D_{R}. The gaps 34 are furthermore closed in the stacking direction 4.

The accumulator arrangement 1 is now shown during operation in FIG. 16. Due to the charging state or the aging, the bearing surfaces 3 of the respective battery cells 2 have deformed. Due to the fact, however, that the separating layers 14 of the cooling element 7 are flexible, they abut against the bearing surfaces 3 of the battery cells 2, independently of the shape thereof, at a pressure, which is built up by the cooling fluid. Independently of the deformation of the battery cells 2, the heat exchange between the battery cells 2 and the cooling fluid can thus take place in the interior 15 of the cooling element 7. An excessive clamping of the battery block 5 in the stacking direction 4 is furthermore prevented, and the battery block 5 remains clamped, independently of the deformation of the battery cells 2, at a constant clamping force in the stacking direction 4.

In summary, the deformation of the battery cells 2 in the accumulator arrangement 1 according to the invention is not limited as a result of the charging state or of the aging, and an excessive clamping of the battery block 5 in the stacking direction 4 can be prevented. The fluid distributor 8 furthermore remains free from tension and the risk of a leakage can thus be minimized. The battery cells 2 can furthermore be cooled effectively and on both sides, so that the service life of the battery cells 2 as a whole can be extended in an advantageous manner. The cooling elements 7 further combine thermal and mechanical functions, so that the overall construction of the accumulator arrangement 1 can be simplified.

1. An accumulator arrangement for a hybrid or electric vehicle, comprising:
a plurality of rigid battery cells respectively having a plurality of bearing surfaces disposed opposite one another;
the plurality of battery cells facing one another with the plurality of bearing surfaces and stacked to form a battery block in a stacking direction;
a cooling device including a plurality of cooling elements through which a cooling fluid is flowable;
a respective cooling element of the plurality of cooling elements arranged between adjacent battery cells of the plurality of battery cells and clamped thereto to form the battery block;
wherein the respective cooling element abuts against a bearing surface of each of the adjacent battery cells facilitating a transfer of heat; and
wherein the cooling device further includes a fluid distributor having a variable shape in the stacking direction and through which the cooling fluid is flowable from a flow connection to a return connection via a fluid chamber of the fluid distributor, and wherein the fluid distributor is fluidically connected to the plurality of cooling elements.

2. The accumulator arrangement according to claim 1, wherein:
between adjacent cooling elements of the plurality of cooling elements, the fluid distributor has a deformation area of a plurality of deformation areas which deforms in response to a deformation of the fluid distributor in the stacking direction; and
when the battery block is not clamped, the fluid distributor is not deformed in the plurality of deformation areas, and when the battery block is clamped, the fluid distributor is deformed in the plurality of deformation areas such that the fluid distributor remains tension-free in the stacking direction in response to deformation of the battery block.

3. The accumulator arrangement according to claim 2, wherein:
the respective cooling element has a fluid ingress and a fluid egress arranged on a bottom side of the respective cooling element spaced apart from one another; and
the fluid ingress is fluidically connected to a fluid inlet of the fluid distributor, and the fluid egress is fluidically connected to a fluid outlet of the fluid distributor.

4. The accumulator arrangement according to claim 3, wherein at least one of:
an assembly distance defined in the stacking direction between adjacent cooling elements of the plurality of cooling elements is larger in non-deformed deformation areas than a respective cell thickness of the plurality of battery cells defined in the stacking direction; and
an element distance defined in the stacking direction between adjacent fluid inlets of the fluid distributor and between adjacent fluid outlets of the fluid distributor is larger when the battery block is not clamped than when the battery block is clamped.

5. The accumulator arrangement according to claim 3, wherein:
at least one of i) at least one sealing contour and ii) at least one sealing surface, is disposed on the respective cooling element around the fluid ingress and around the fluid egress; and
the at least one of i) the at least one sealing contour and ii) the at least one sealing surface seals at least one of i) a connection point between the fluid ingress and the fluid inlet and ii) a connection point between the fluid egress and the fluid outlet, to an outside.

6. The accumulator arrangement according to claim 1, further comprising a plurality of flow channels disposed within the fluid chamber configured to supply the cooling fluid from the flow connection to the plurality of cooling elements and to discharge the cooling fluid from the plurality of cooling elements to the return connection.

7. The accumulator arrangement according to claim 1, wherein:
the fluid distributor is defined by an upper shell and a lower shell which are coupled to one another in a fluid-tight manner; and
the fluid chamber is defined between the upper shell and the lower shell.

8. The accumulator arrangement according to claim 7, further comprising a connection structure arranged on at least one of the upper shell and the lower shell within the fluid chamber, wherein the connection structure includes at least one of punctiform connection areas, oval-shaped connection areas, lens-shaped connection areas, and linear connection areas.

9. The accumulator arrangement according to claim 1, wherein the respective cooling element includes a frame which extends around the bearing surface of each of the adjacent battery cells on an edge side in a circumferential direction such that an interior of the respective cooling element, through which the cooling fluid is flowable, is disposed between the frame and the adjacent battery cells.

10. The accumulator arrangement according to claim 9, wherein the frame is coupled to the bearing surface of each of the adjacent battery cells in a fluid-tight manner such that the bearing surface of each of the adjacent battery cells defines the interior of the respective cooling element with the frame.

11. The accumulator arrangement according to claim 9, further comprising a plurality of flexible separating layers defining the interior of the respective cooling element with the frame, wherein the plurality of flexible separating layers are coupled to the frame in a fluid-tight manner transversely to the stacking direction.

12. The accumulator arrangement according to claim 9, wherein, on the frame at least on one side and at least area by area, a holding collar is arranged, the holding collar protruding away from the frame in the stacking direction and securing an abutting battery cell of the adjacent battery cells transversely to the stacking direction at least area by area.

13. The accumulator arrangement according to claim 1, wherein at least one of:
the battery block is clamped by at least one cell block tension rod extending in the stacking direction, and the respective cooling element is coupled to the at least one cell block tension rod in a positive manner via at least one form-fitting unit; and
the battery block is clamped by at least one cell block tie anchor extending in the stacking direction.

14. The accumulator arrangement according to claim 1, wherein the plurality of cooling elements are arranged in the battery block in an alternating manner with the plurality of battery cells in the stacking direction, wherein each of the cooling elements follows one of i) each of the plurality of battery cells and ii) two abutting battery cells of the plurality of battery cells.

15. The accumulator arrangement according to claim 1, further comprising a housing including a top part and a bottom part coupled to one another in a fluid-tight manner defining a fluid-tight receiving space for the battery block.

16. The accumulator arrangement according to claim 1, wherein:
the fluid distributor is structured as a separate flat component configured to supply the cooling fluid the plurality of cooling elements and to discharge the cooling fluid from the plurality of cooling elements; and
the fluid chamber is defined by the fluid distributor and is disposed completely inside the fluid distributor.

17. The accumulator arrangement according to claim 6, wherein the plurality of flow channels are arranged as a Tichelmann circuit.

18. The accumulator arrangement according to claim 8, wherein the at least one of the punctiform connection areas, the oval-shaped connection areas, the lens-shaped connection areas, and the linear connection areas are oriented in a flow direction of the cooling fluid.

19. The accumulator arrangement according to claim 13, wherein the battery block is clamped by the at least one cell block tension rod, and wherein the at least one cell block tension rod includes a plurality of mounting brackets protruding therefrom transversely to the stacking direction on both sides configured to couple the accumulator arrangement to a vehicle.

20. An accumulator arrangement for a hybrid or electric vehicle, comprising:
a plurality of rigid battery cells stacked along a stacking direction defining a battery block, each of the plurality of battery cells having a plurality of bearing surfaces disposed opposite one another and facing in the stacking direction;
a cooling device including a plurality of cooling elements through which a cooling fluid is flowable, each of the plurality of cooing elements arranged between a pair of adjacent battery cells of the plurality of battery cells and clamped thereto, each of the plurality of cooling elements abutting a bearing surface of each of the adjacent battery cells facilitating a transfer of heat;
wherein the cooling device further includes a deformable fluid distributor fluidically connected to the plurality of cooling elements, the deformable fluid distributor including a fluid chamber through which the cooling fluid is flowable from a flow connection to a return connection; and
wherein the deformable fluid distributor is structured to deform when a deformation force is applied in the stacking direction.
